(19) United States
(12) Patent Application Publication
(10) Pub. No.: US 2025/0088822 A1
(43) Pub. Date: Mar. 13, 2025

(54) System and method of communicating between a user device and a venue device located within a gaming venue using ultra-wideband localization

(71) Applicant: Tavolo Intellect LLC, Grosse Pointe, MI (US)

(72) Inventor: Ryan Patrick McClellan, Grosse Pointe, MI (US)

(21) Appl. No.: 18/884,502

(22) Filed: Sep. 13, 2024

Related U.S. Application Data
(60) Provisional application No. 63/582,281, filed on Sep. 13, 2023.

(51) Int. Cl. H04W 4/021; H04W 4/33

(52) U.S. Cl. CPC H04W 4/021; H04W 4/33

(57) ABSTRACT

A system and method of communicating between a user device and a venue device located within a gaming venue, the method includes establishing an electronic communication link, using a Bluetooth signal, between the user device and at least one venue device within a range of the user device in the gaming venue; detecting, by a detector of the venue device, using ultra-wideband localization, presence or location of the user device relative to the venue device; and then communicating, by a mobile application residing on the user device, with the venue device, via the electronic communication link and/or via Wifi or a cellular network.

### CROSS REFERENCE TO RELATED APPLICATIONS

This application claims priority to and the benefit of U.S. 63/582,281 filed on Sep. 13, 2023, the entirety of which is hereby incorporated by reference herein for all purposes.

### FIELD

These teachings relate generally to a system and method for detecting a user device within a predetermined region or distance from a venue device and communicating between the user device and the venue device.

### BACKGROUND

Some casino patrons utilize one or more physical items for making transactions at a casino. For example, a patron may use a cash, a debit or credit card, and/or a loyalty card at a casino. However, these physical items have shortcomings. For example, cash is becoming less common, and while some casinos accept credit and/or debit cards, some credit and debit card transactions are tied to large transaction fees and the transactions can be slow and tedious.

Some casinos offer rewards for players who frequently visit and play at casinos. To track these rewards and rate players, a player typically presents a physical loyalty card to the casino before or during game play. However, some players forget or lose their loyalty card. In these instances, a player can provide their driver's license and a supervisor will input the player's information into the gaming system. However, this may distract the supervisor from performing their core duties and/or delay game play.

Some casinos utilize methods for phones to be utilized as a method of transferring funds to the table. These methods require the user to touch a phone to a receiver using NFC/RFID or to allow a staff member to handle their phone imposing liability on the casino as risk of damage is transferred to the staff member handling the device. These methods are quite cumbersome and require numerous pieces of equipment.

Some casinos provide offers to their players in the form of free play or match play. Such offers are mailed to the players in the form of a coupon. These coupons are then presented at the gaming table for use at the table. This method is inconvenient as the player may have forgotten their coupon. In addition, the absence of the coupon may prevent the user from making a decision to go to the casino while they are in the proximity.

Accordingly, improvement in the art may be desired.

### SUMMARY

These teachings relate generally to a system and method for detecting a user device within a predetermined region or distance from a venue device and then communicating between the user device and the venue device.

The system and method according to these teachings may utilize ultra-wide band technology or localization (UWB) as a localization methodology for detecting or determining a location, position, and/or movement of a user device. The system and method according to these teachings may utilize Bluetooth to establish an electronic communication link between a user device and a computing device, a venue, and/or a venue device. . . . The system and method to these teachings may utilize Bluetooth technology for communicating between the user device and the venue device. The communication between the user device and the venue device may take place between a mobile application running on the user device or phone and a computing device, the venue, and/or a venue device. In some configurations, the communicating step may also, or may instead, take place via a Wifi or a cellular network. In some configurations, Bluetooth technology may also be utilized for detecting that a user device is within a predetermined region or distance from the venue device. In some configurations, Bluetooth technology may also be utilized in determining that a user device is no longer present or located within a predetermined region or distance from the venue device. If Bluetooth is utilized to determine if the user device is or is not present or located within a predetermined region or distance from the venue device, the system and/or method may do so by monitoring or comparing a signal strength of the Bluetooth signal or strength of the electronic communication link between the venue device and the user device. If it is determined that the strength of the Bluetooth signal is dissipating or is less than or is simply different (less than or greater than) than a strength of the Bluetooth signal previously established, then the system and or method according to these teachings may determine or suspect that the user or user device is no longer within the predetermined region and or a distance between the user device and the venue device is increasing, which may be indicative of the user leaving or moving away from the venue device and or the predetermined region of interest. For example, the signal strength may be greater than the baseline signal strength due to triangulation where a signal is picked up by a different detector or computing device or anchor and gets stronger at that device than the base line signal. This may indicate the user is not longer near or present at the original location.

Advantageously, the teachings herein provide an improved and more efficient system and method for accurately detecting a user device within a predetermined region or distance from a venue device and communicating between the user device and the venue device.

The systems and methods described herein utilize an ultra-wideband (UWB) communication, localization, or detection protocol or technology. UWB is a short-range, wireless communication protocol that operates through radio waves. UWB operates at very high frequencies and can be used to precisely detect the location of people, devices, and assets. UWB signals can be identified as signals with a spectrum width of more than 500 MHz and the range from 3.1 to 10.6 GHz. UWB is based on the Institute of Electrical and Electronics Engineers (IEEE) 802.15.4a and 802.15.4z standards that can enable very accurate measure of the time of flight of the radio signal, leading to centimeter accuracy distance/location measurement. Additionally, UWB also offers data communication that may be used for communicating between two or more devices.

The systems and methods described herein utilize a Bluetooth communication, localization and/or detection protocol or technology, Bluetooth is a communications technology and a series of specifications provided by the NFC Forum, Inc., which are expressly incorporated by reference herein for all purposes. Unless otherwise noted, the Bluetooth signal or communications protocol may be Bluetooth or Bluetooth low energy (BLE). These terms may be used synonymously unless otherwise noted herein.

Generally, these teachings provide a system and method of/for communicating between a user device and a venue device located within a gaming venue comprising: establishing an electronic communication link, using Bluetooth, between the user device and at least one venue device within a range of the user device; detecting, by a detector or detection device of the venue device, using ultra-wideband localization, presence or location of the user device relative to the venue device; and then communicating, by a mobile application residing on the user device, with the venue device, via the electronic communication link and/or via Wifi or a cellular network.

### BRIEF DESCRIPTION OF THE DRAWINGS

FIG. 1 is a perspective schematic of an exemplary system according to these teachings.

FIG. 2 is a flow diagram of an exemplary method and steps according to these teachings.

FIG. 3 is a perspective schematic of an exemplary venue device in a venue utilizing the system and method according to these teachings.

FIG. 4 is a flow diagram of an exemplary transaction at a venue associated with the method and system disclosed herein.

FIG. 5 is a flow diagram of an exemplary transaction at a venue associated with the method and system disclosed herein.

FIG. 6 is a flow diagram of an exemplary transaction at a venue associated with the method and system disclosed herein.

FIG. 7 is a flow diagram of an exemplary transaction at a venue associated with the method and system disclosed herein.

FIG. 8 is a flow diagram of an exemplary transaction at a venue associated with the method and system disclosed herein.

FIG. 9 is a schematic view of an example computing device that may be used to implement the system and method described herein.

### DETAILED DESCRIPTION

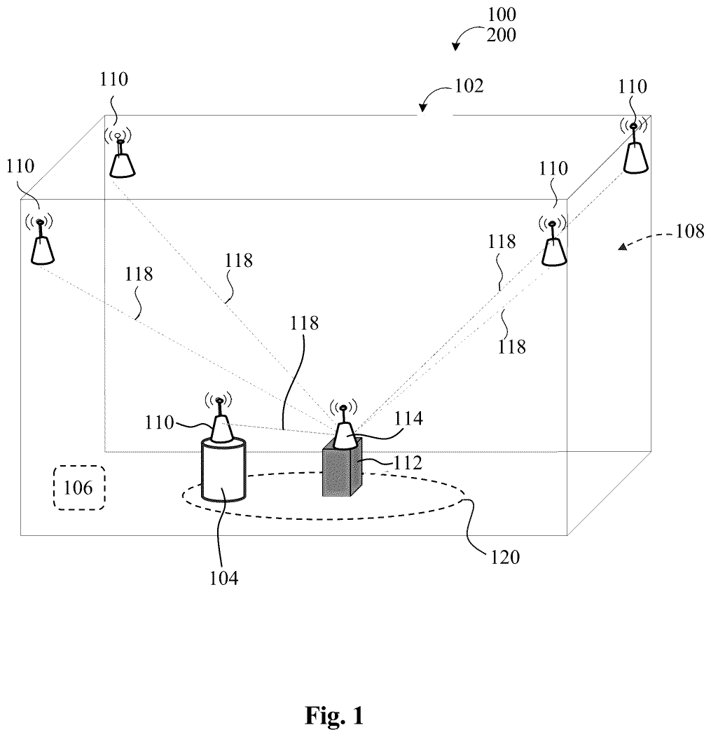

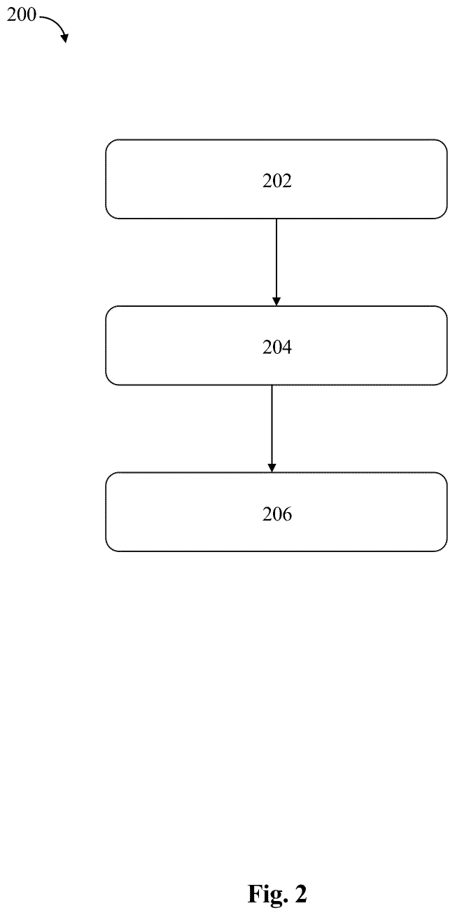

FIG. 1 illustrates an exemplary system 100 according to these teachings. FIG. 2 illustrates an exemplary method 200 according to these teachings.

The method 200 may be executed by or within a system 100 that may be located within a venue 102. The system 100 or venue 102 may comprise one or more venue devices 104, one or more computing devices 106, and a computer network 108 such as a wireless local-area network (WLAN).

A venue 102 may be a gaming venue. The venue 102 may be a casino. In some configurations, the venue 102 may be a hotel, amusement park, store, stadium, airport, cruise ship, an indoor space, an outdoor space, the like, or any combination thereof.

A venue 102 may comprise one or more venue devices 104. A venue device 104 may be a device that a user or user device interacts or communicates with. A venue device 104 may be a device that a user or user device uses to transact with the venue. A venue device 104 may be a device that an employee or agent of the venue 102 uses to transact with the venue, a venue device, a user device, a user, or any combination thereof.

For example, a venue device 104 may be a gaming device. The venue device may be or may include one or more gaming tables (i.e., blackjack, roulette, baccarat, craps, pai gow, etc.), electronic gaming machines (slot machines, poker machines, keno), cash machines (ATMs), kiosks, ticket-in, ticket out (TITO) machines, limit signs, TVs, digital signs, displays, or any combination thereof. In some configurations, a venue device 104 may be one or more chairs, bars, casino cages, ash trays, plates, silverware, drinks, cocktail trays, card shoes, and/or gaming or wagering chips. In some configurations, a venue device 104 may be a device that is utilized by an employee or agent of the venue device 102. For example, a venue device 104 may be a badge or identification card worn or used by an employee or agent of the venue device 102 (for example, a badge or card an employee may clock in or tap in, clock out or tap out, etc.). In some configurations, one or more of the venue devices may be a device that is configured to transmit data but doesn't receive data, such as an ultra-wideband tag. In some configurations, one or more of the venue devices may be a device that is configured only to receive data but doesn't send or transmit data. In such a configuration, the venue device that only transmits data can be used to send a pulse or signal to one or more devices that are configured to receive the pulse or signal (e.g., an anchor or computing device), and then the anchor or computing device can triangulate pulse or signal to determine the relative position of the venue device.

In some configurations, the one or more venue devices may be a medium or device for communicating or processing transactions between a user device and a back end server or computing device. For example, the user device may exchange electronic signals (i.e., Bluetooth, wifi, cellular, etc.) with an intermediate venue device which way then correct, store, interpret, translate or redirect the one or more signals to one or more other user devices or computing devices. For example, a vending device may be a cloud based server or system.

In some configurations, after the user device establishes the electronic communication link, the user device or mobile telephone they connect to a cloud based system for processing transactions with the venue and or venue device.

In one example, a venue device may be a sign that is illustrated and described in US Publication No. US 2023/0410593 published on Dec. 21, 2023, the entirety of which is hereby incorporated by reference herein for all purposes.

The system 100 may include one or more computing devices 106. The one or more computing devices may generally include one or more processors, one or more memories, one or more interfaces/controllers, one or more communication ports for receiving and sending data or signals, one or more computer programs, one or more computer algorithms. The one or more computing devices may be configured to perform or execute one or more of the steps of the method 200 according to these teachings. The one or more computing devices may include machine learning, deep learning, artificial intelligence.

The one or more computing devices 106 may communicate with one or more user devices, one or more venue devices, one or more tags, one or more anchors, one or more detectors or detection devices for detecting an anchor, tag, venue device, and/or one or more other devices and execute one or more step of the method disclosed herein over the network 108. The network 108 may be a hard-wire network, a wireless network, or both. Further description of the computing device 106 is discussed below.

One or more components of the computing device 106 may be located locally, on-site at the venue or venue device. One or more components of the computing device 106 may be located off site from the venue or venue device, for example in the cloud or other physical location apart from than the venue. One or more components of the computing device 106 may be located locally on/at a venue device 104, such as a gaming table, slot machine, limit sign, etc. One or more components of the computing device 106 may be part of an existing computing device 106 at the venue, which can be configured to execute one or more steps of the method according to theses teachings.

The computing device may be configured to act or function as a calibration device to calibrate the one or more anchors. For example, the calibration may include of one or more anchors using a communications network (cellular, WiFi, UWB, etc.) to synchronize timing and communicate Ultra Wideband localization information with the computing device. The computing device may perform a triangulation function for determining the location and/or position of the one or more anchors. Such calibration may automatically determine the physical location of each anchor, relative to each other, translated to a virtual space. Such calibration may be used to determine the physical location of each anchor, relative to each other, translated to a virtual space, in situations where, for example, one or more venue devices or tags or anchors are added to the venue, or moved within the venue (e.g., moved to a new location, repositioned, re-oriented, etc.)

The system 100, venue 102, and/or venue devices 104 may comprise one or more beacons or anchors 110. The one or more beacons or anchors 110 may be, or may include a communications tool or device for communicating (sending and/or receiving) data, signals, information, etc. with/between the computing device 106, the one or more venue devices 104, one or more user devices 112, or a combination thereof. The data, signals, information may be communicated to, from, or between one or more user devices, one or more venue devices, one or more anchors, one or more tags, one or more computing devices, or any combination thereof.

A beacon or anchor 110 may be or may comprise one or more data transmitters, data receivers, detectors, or any combination thereof. The one or more detectors or detection devices may be configured to detect one or more computing devices, user devices, tags, or any combination thereof. The one or more beacons or anchors 110 may include electronic circuitry that enables data and/or signal transmission and/or reception, data communication, UWB communication, Bluetooth communication, or any combination thereof. The one or more beacons or anchors 110 may detect and/or communicate with one or more venue devices 104, user devices 112, beacons or tags 114, and/or the computing device 106 over the network 108.

In some configurations, the one or more anchors 110 may function as a computing device 106. In such a configuration, the one or more anchors 110 may comprise one or more features or capabilities of the computing device 106 so that the anchor 110 can perform one or more of the functions of the computing device 106 disclosed herein. Accordingly, an anchor 110 may be a computing device 106.

The one or more beacons or anchors 110 may be at least temporarily fixed (i.e., permanently or temporarily). This means that the one or more beacons or anchors 110 are not intended to be moved on a regular basis.

For example, the one or more beacons or anchors may be disposed or located on/in/at a ceiling, floor, and/or walls of the venue 102 or venue region 120. For example, the one or more beacons or anchors may be located near, on, under, or in one or more tables, carts, shelves, signs, chairs, limit signs, one or more venue devices 104. For example, the one or more beacons or anchors may be located on a specific floor or region of the venue, in a restaurant, pool, pool deck, sauna, gym, restaurant, bar, etc. of the venue.

The one or more beacons or anchors 110 may be at least temporarily moveable. This means that the one or more beacons or anchors 110 can be attached to ort part of a device or venue device that is moveable. When a device or anchor is moved, then the system and/or method may perform a recalibration step, where using ultra-wideband localization, the layout, position and/or location of the anchor and other anchors can be detected and determined.

A recalibration may take place automatically after a predetermined amount of time, for example on a weekly monthly quarterly and or annual basis to ensure that the virtual map or layout of the one or more venue devices, anchors, beacons, or combination thereof is accurate. The accuracy of the layout may be impacted if one or more venue devices are moved and or added to the venue. In other configurations, a recalibration may take place manually at the direction of a user, employee, or agent of the venue. A recalibration is used here and may mean that the computing device, system, in our method disclosed here and may perform a triangulation function to locate a location of the one or more venue devices, anchors, tags, or combination thereof relative to one another and or within the defined venue.

The calibration or recalibration may take place via any suitable method of ultra wide band localization or detection including but not limited to the TDOA method. For example, Bluetooth and TWR may be used to determine the orientation and distances between the anchors and/or tags in the venue.

In some configurations, one or more anchors may be placed throughout the venue. For example, one or more anchors may be placed throughout the venue on the one or more walls, ceilings, floors, venue devices, etc. One or more additional anchors may be placed on the one or more venue devices, such as on one or more gaming tables. Do you wanna more anchors on the then you may be used to create or layout the venue. The one or more anchors placed on the one or more venue devices and our gaming tables may be used to create many venues or regions of interest within the main venue. This may create a mesh of signals that are generated and communicated between the various computing devices and anchors. The signals may be synchronized in order to determine the orientation and distances between the anchors of the venue and the anchors of the venue devices. Advantageously, this may allow for the computing device to determined with greater accuracy a location of A tag or user device relative to any of the anchors within the venue. Moreover, this may allow for a more accurate layout of the venue device to be created.

One or more user devices 112 may be used with the system 100 and/or method 200 disclosed herein. In some configurations, one or more user devices 112 may be part of the system 100. However, in other configurations, the one or more user devices 112 may be ancillary or auxiliary devices that are configured to interact with the system 100 disclosed herein via the method 200 disclosed herein.

A user device 112 may belong to or may be used by a user or patron of the venue to interact with the venue or venue device. For example, a user device may be one or more smart phones, watches, rings; other wearable jewelry, player profile or loyalty cards; radio transmitters, radio receivers, etc. Another example of a user device may be an AIRTAG; etc.

In some instances, a user device 112 may belong to or may be used by an employee or agent of the venue to interact with the venue or venue device. For example, the one or more user devices 112 may be one or more gaming or wagering chips; employee identification or transaction cards; employee or player loyalty profile cards; cocktail trays; lanyards; etc.

The one or more user devices 112 may comprise one or more tags 114.

A user device 112 and/or a venue device may also be referred to herein as an asset. The system and/or method according to these teachings may be used to locate, track, communicate to/from/with the one or more assets.

The one or more beacons or tags 114 may be one or more data transmitters, data receivers, detectors, detection devices, asset detectors, or a combination thereof. The one or more beacons or tags 114 may include electronic circuitry that enables data transmission and/or reception, data communication, UWB communication, Bluetooth communication, or any combination thereof. The one or more tags 114 may communicate with one or more beacons or anchors 110, venue devices 104, and/or computing devices 106. The one or more beacons or tags may communicate with one or more beacons or anchors 110, venue devices 104, and/or computing devices 106 over the network 108 and/or via another network or backchannel.

The one or more beacons or tags 114 may be at least temporarily moveable. This means that the one or more beacons or tags 114 are intended to be moved on an at least regular basis. The one or more beacons or tags 114 may be at least temporarily stationary. This means that the one or more beacons or tags 114 are intended not to be moved on an at least regular basis. For example, a tag may be placed on a table, gaming table, or slot machine that is not intended to be moved in the regular course of business. In other configurations, a tag may be on a user device such as a smart phone that is moveable.

The one or more beacons or tags 114 may be configured to detect or be detected by one or more computing devices, user devices, other tags, anchors, or any combination thereof. The one or more beacons or tags 114 may communicate by one or more communication protocols such as Wifi, Bluetooth, cellular, ultra-wideband, etc.

The one or more beacons or tags 114 may be attached to or provided on one or more assets. The location or position of the one or more assets can be tracked or identified using ultra-wideband technology and localization methods or steps disclosed herein by interacting with the one or more

The one or more beacons or tags 114 may be assigned a unique identifier or code and associated with a respective device, item, asset, or owner. For example, a beacon or tag 114 associated with an asset such as a loyalty card may be assigned a unique identifier that is associated with a specific or particular loyalty card and profile corresponding to an individual player. For example, a beacon or tag 114 associated with a particular venue device, cocktail waitress, dealer, or security personal of the casino may be assigned a unique digital identifier that is associated with a specific venue device, cocktail waitress, dealer, or security personal. The unique digital identifier associated with each beacon or tag 114 may be communicated to/between the one or more venue devices 104, anchors 110, computing device 106, venue 102, or a combination thereof over or via the network 108.

Referring to both FIGS. 1 and 2, the method 200 comprises one or more steps of/for communicating between a user device 112 and a venue device 104 located within a venue 102.

One or more of the method steps disclosed herein may be performed in any order; some steps may be omitted; some steps may be duplicated; some steps may be rearranged into a different order; some steps may be combined with other steps; some steps may be separated into two or more steps; two or more steps may be combined into a single step; or any combination thereof.

One or more of the method steps disclosed herein may take place or be executed automatically. One or more of the method steps disclosed herein may take place or be executed at the direction of a user of a user device 112 and/or at the direction of an employee or resident of the venue 102 or venue device 104. In some configurations, one or more method steps may immediately follow the occurrence or non-occurrence of a preceding method step or activity. In some configurations, a recommendation, suggestion, or warning may be communicated to a user of the user device 104 and/or to an employee or resident of the venue 102 or venue device 104 that a method or step is recommended to take place or will automatically take place within a predetermined amount of time. In these configurations, the user of the user device 104 and/or the employee or resident of the venue 102 or venue device 104 may be required to take one or more affirmative steps for the method step to take place.

The method 200 may include a number of initial or pre-steps that can, should, or must take place before one or more other steps of the method 200 can be properly executed. These initial pre-steps may or may not be part of the actual method disclosed herein. For example, a method pre-step may include: acquiring a user device; downloading or acquiring a mobile software application onto a user device; acquiring a license for using the user device or mobile software application; updating a mobile software application on the user device to a latest version; downloading or acquiring a software application onto a venue device; updating a software application on the venue device to a latest version; inputting or populating user information into the mobile software application (e.g., populating user information or player profile information); activating the user device and/or the mobile application; connecting the user device to the network 108; activating or turning on location services on the user device and/or tag; manipulating the user device so that the mobile application is active and on the forefront (i.e., on the screen); charging the user device or changing a battery in the user device; registering the user device onto the network; or any combination thereof.

The method 200 may include a step 202 of establishing an electronic communication link between the user device 112 and the venue device 104. The communication link may be established over the network 108. The communication link may be established by Bluetooth. However, other communication links may be established via other communication protocols. For example, the network 108 and/or the communication protocol may include, for example, Zigbee, LoRaWAN, WiFi, Z-Wave, Bluetooth Low Energy, Nb-iot, Sigfox, Thread, Cellular, etc. The communication link may enable the venue 102, the venue device 104, computing device 106, anchor 110, user device 112, tag 116, etc. to communicate with one another (i.e., to send/receive data, signals, information, etc. over the network 108). The communication link may include an exchange of tokens or a handshake to ensure the communication between the user device and the one or more venue devices is authorized by a user, the user device, the venue, the venue device, the system, the method, the computing device, the network, or any combination thereof. The communication link may be established between one or more tags, anchors, user devices, venue devices, computing devices, network, or any combination thereof.

The method 200 may include a step 204 of detecting a location of the user device 112 and/or determining a location and/or presence of the user device 112 relative to the venue device or within the venue. The method step 204 may include determining a location of the user device 112 and/or confirming presence of the user device 204 and/or a tag within a predetermined region or distance from the venue device 104 in the venue 102. The detecting step 202 may be executed via a suitable communication or location protocol such as ultra-wideband localization.

The detecting step 204 may be performed by one or more detectors or r detection devices associated with the venue device, user device, anchor, tag, computing device, network, or any combination thereof. A detector or detection device may comprise a device for receiving, acknowledging, understanding, sending, correlating, understanding, and/or otherwise interpreting one or more signals or waves generated by one or more venue devices, user device, anchor, tag, computing device, network, or any combination thereof. The one or more detectors or detection devices may comprise one or more processors, memories, computing devices, may be connected to the network, or any combination thereof.

In or during the detecting step 204, one or more signals or radio waves 118 may be communicated to or between one or more of the beacons or tags 114 of the user device 112 and the one or more of the beacons or anchors 110 of the venue 102 and/or venue devices 104 to determine the location of the user device 112 and/or if the user device 112 is within a predetermined region 120 or distance from the venue device 104.

The one or more tags and/or anchors 110 may be used to establish a vector or vectors of the predetermined region 120 within the venue. Establishing the vector or vectors may be manually input relative to the anchor, or via a calibration method using a user device 112, venue device 104, beacon or tag 114, anchor, etc. to trace an outline of the predetermined region 120. In some instances, such traced region may add an additional buffer zone thus creating a wider region than the original traced region. Such predetermined region may have one or more secondary regions added such as a Player Region, a Dealer Region., a spectator region, etc. The vector or vectors may be stored on the computing device 106, an anchor 104, a tag, a user device, a venue device, or any other networked device. This vector information can be communicated to the user device 112 via or over a network (cellular/wifi/etc.) or the user device can download the information from the anchor 110 or computing device 106 via Bluetooth communication. In or during the detecting step 202, using the vector information, the user device 112, or more specifically the mobile device, can then determine if the user device 112 is within the predetermined region 120 defined by the one or more anchors 110. If the user device 112 or the computing device 106 determines that the user device 112 is within the predetermined region 120 or zone of interest, the user device 112 may be enabled or activated to engage in one or more transactions with the venue and/or venue device. In some other configurations, a user device 112 or one or more tags 114 of the user device 112 may locate or detect one or more of the anchors 110 to determine which of the anchor(s) 110 is closest to the user device 112 so that the system 100 can determine the location of the user device 112 using one or more of the detecting or locating steps disclosed herein. A venue region 120 may be a predetermined area or a certain distance or perimeter around a particular venue device 104 (for example, 3-5 feet from a slot machine or card table venue device 104 as a non-limiting exemplary distance). For example, a venue region 120 may be a dealer region, where a dealer typically sits or stands. For example, a venue region 120 may be a player region, where a player typically sits or stands during game play. For example, a venue region 120 may be a security region, where a pit boss or venue security sits or stands for monitoring game play and overall venue activity. For example, a venue region 120 may be a region where a player may cash in/out wagering chips, a food or restaurant area, an area reserved for smoking, an area reserved or intended for persons over a certain age (i.e., senior citizens), an area reserved or intended for persons with certain disabilities (i.e., handicapped). In some configurations, a venue region 104 may be a particular area of the venue 102. For example, the venue region 104 may be a region, space, or boundary that a person (e.g., a casino patron and/or employee) may be located in or entering. For example, a venue region may be, or may include, a restaurant, a bar, a gaming area (i.e., a blackjack room, high-limit room, etc.), a dealer area, player's a venue employees-only area, hotel, hotel room, pool, spa, restroom, massage room, etc.

The system 100 and/or the one or more computing devices 106 may triangulate the presence and/or location of the anchor or tag 114 within the predetermined region or venue region 120 based on signals 118 that are communicated to or between one or more of the beacons or anchors 110 of the venue 102 or venue device 104 and the beacon or tag 114 of the user device 112. The system 100 or computing device 106 may then determine an XYZ coordinate or location of the user device 112 within the venue 102 or venue region 120. One or more software, hardware, algorithms, look up tables, etc. on the computing device 106, network 108, etc. may be used during this step.

Due to the triangulation and angle or arrival of the signal at the one or more tags, anchors, computing device, the system and or method according to these teachings is able to understand your position or direction of the region of interest. This may help to differentiate between one side of a gaming table where a dealer or employee may stand (e.g., a dealers position) and another side of the table where a player of the game may stand or sit. This is in contrast to other communication methods where the computing device may not exactly know on which side of the table that particular player or dealer position is located. Moreover, the triangulation and angle of arrival of the signal at the one or more tags, anchors, computing devices, may be used to determine the exact seat or spot at a gaming table. This may be helpful in the method step disclosed herein in which a player can reserve a particular spot or seat at a gaming table. Moreover in the event that the drink or food order is placed by a user via a user device, the waitress or staff will know exactly which seat to deliver the food or drink to, as opposed to knowing only a general area and then asking various players who ordered the particular food or drink. Advantageously, this may allow for a more personalized experience without bothering other people to inquire who ordered the particular food or drink.

In this regard, the mobile application and/or the user device may be configured for wayfinding and/or location identification using the user device and the detection method and system herein. Because the orientation and location of the user device is known, a user may input a destination into the mobile device and the system and method disclosed herein may provide a map or route for the user to follow in order to reach the destination or predetermined region of interest. Due to the triangulation of the one or more anchors, tags, user devices, venue devices, venue to voice anchors, venue anchors, or combination thereof, the system in our methods disclosed here and may provide an accurate route or map for the user to follow. And because the triangulation can be updated in real time, if the user or user device is determined to not follow the path, then the mobile device or application may provide an updated route or detour

The system 100 and/or the one or more computing devices 106 may determine the location of the beacon or tag 114 of the user device 112 within the venue 102 or venue region 120 using one or more of any of the following locating methods: a time difference of arrival method (TDOA), a reverse time difference of arrival method (reverse TDOA), a two-way ranging method (TWR), and/or a phase difference of arrival method (PDOA).

A time difference of arrival method (TDOA method) is a scalable method for determining the location of one or more beacons or tags 114 of the user device 112 within the venue 102 or venue region 120. Because beacons or tags 114 may only need to transmit once (e.g., a single signal) during the TDOA method, the beacons or tags 114 may use very little power and therefore have a very long battery life. Multiple beacons or anchors 110 may be deployed in fixed and known location in the venue 102 and may be tightly time synchronized. When a beacon or tag 114 emits or sends a signal 118 (i.e., a “blink” signal), one or more beacons or anchors 110 that receive the signal 118 will timestamp arrival of the signal 118 at the anchor 110, based on the common synchronized time-base. The timestamps from multiple anchors 110 can be forwarded to the computing device 106 or data processing hardware, which can run one or more software, algorithms, and/or multilateration algorithms to determine the location of the tag 114 of the user device 112 based on differences in the time that the signal 118 arrived at the one or more anchors 110. When there are three or more anchors 110, the computing device 106 or data processing hardware can provide a 3D location or position of the tag 114 or user device 112 within the venue 102 or venue region 120.

A reverse time difference of arrival method (reverse TDOA) method operates akin to a Global Positioning System (GPS), which may be generally understood by a person having skill in the art as a satellite-based radio-navigation system that provides location, speed, and time information. If utilizing a reverse TDOA method, the one or more anchors 110 may emit or transmit one or a plurality of synchronized signals 118 (i.e., blinks with fixed/known offsets to avoid collisions) and the one or more tags 114 of the user device 112 may use TDOA and multilateration algorithms to compute the location or position of the tag 114 or user device 112 within the venue 102 or venue region 120.

In a two-way ranging method (TWR), one or more anchors 110 are configured to send, transmit, or emit one or more signals 118 to the one or more tags 114, that, in turn, return the one or more signals 118 back to the one or more anchors 110. The computing device 106 or data processing hardware can measure the time of flight of the one or more signals 118 between one or more of the anchors 110 and the tag 114 to derive a distance between one or more of the anchors 110 and the tag 114, thereby, determining the location or position of the tag 114 or user device 112 within the venue 102 or venue region 120.

A phase difference of arrival method (PDOA) enables two devices, for example, devices 110 and 112, to calculate their relative positions within the venue 102 or region 120 without the need for any other infrastructure, using a combination of distance and directional information. This may be beneficial for peer-to-peer applications or to reduce the amount of infrastructure that needs to be deployed. For PDOA, one of the devices must carry at least two antennae. When the first device receives a signal from the second device, it measures the difference in the phase of the arriving signal at each antenna. Based on this information, the first device can calculate the angle from which the incoming signal arrived. The first, receiving device is able to determine both the direction and the distance of the second, transmitting device within the venue 102 or venue region 120.

Other localization or location tracking and/or determining methods may be utilized, including GPS, Wi-Fi, cell tower triangular, Bluetooth, and other known positioning or locating systems. The tracking or locating steps may take place over the network 108 associated with the venue 102 or via another network that may be a backchannel network or communication system.

After the user device 112 is located and/or presence of the user device 112 is determined or detected in step 202, step 202 may end at least temporarily. This means that if an ultra-wideband technology is used during step 202, after the user device 112 is located or its presence is confirmed, the ultra-wideband communication of tags and anchors may stop communicating. Additionally, or alternatively, if the mobile software application is paused, turned OFF, or is no longer in the forefront of the user device, then communication or interaction of the tags and anchors via ultra-wideband communication may end.

In some configurations, communication and/or interaction of the user device and the anchors, tags, venue device, computing device, etc. via the Wifi, Bluetooth and/or ultra-wideband communication may end after a predetermined amount of time (e.g., it may time out); after the location of the user device or tag relative to the venue device and/or anchor does not change within a predetermined amount of time (e.g., the user or user device is not moving); and/or after the user or an employee or agent of the venue device takes one or more affirmative steps to disconnect the ultra-wideband, Wifi, and/or Bluetooth communication between the user device, tag, anchors, venue device, etc.

In some configurations, communication and/or interaction of the venue device, user device, tags, anchors, tags, computing device via the ultra-wide band and/or wifi or cellular does not end or time out after a predetermined amount of time (e.g., des not time out). Instead, disconnection may take place if the user, user device, venue device, tag, anchor, computing device, etc. takes an affirmative step to disconnect the communication.

In some configurations, in the event that the ulta-wideband is disconnected for any reason, electronic communication between the user device, tag, anchor, penny device, computing device, etc., may take place via another communication protocol such as Bluetooth, Wifi, cellular, etc. Advantageously, this may allow the system and/or methods according to these teachings continue to function in a way to locate and communicate with a user device without interruption.

The method 200 may include a step 206 of communicating or transmitting initial data or information, by the user device 112 to the venue device 104 (or by the venue device 104 to the user device 112) via the electronic communication link, which was established in step 202 and/or via another communication protocol such as Wifi or cellular . . . .

The transmitting or communicating step 206 may be a request or initialization that is sent by the user device to the venue or venue device (or vice versa) to allow the user device and venue device to communicate. In other words, the venue device may first transmit a request, information, or data to the venue device, or the venue device may first transmit a request, information, or data to the user device. The receiving device (user or venue device) will then need to confirm the request from the sending device (the other of the user or venue device) for the communication link to be established. For example, a request may be sent by the user device with information that includes a player profile that may include information about the user or the player. For example, the player profile may include a player's name, age, player habits, preferred games, win/loss history, loyalty card information, previous gaming table, etc. The player profile may allow the venue to keep track of the user's play time and allow the user or player to earn rewards for spending time and money at the venue. The venue device may confirm that the player profile is in the venue's database and confirm the request. If the player profile is not in the venue device, then the request may be rejected or the user device may be requested to provide additional information. The transmitting step 206 may be a registration step.

The transmitting or communicating step may be executed by a mobile application residing on the user device 112, with the venue device 104, via the electronic communication link, established in step 204 for example, over the network 108.

The transmitting or communicating step 206 may include transferring information, data, signals, etc. between the user device and the venue device. For example, the communicating step 206 may include: transferring money between an electronic wallet or financial institutions and the venue or venue device (e.g., buying in or cashing out); sending drink or food orders from the user device to the venue; reserving one or more spots or seat at a gaming table; reserving one or more spots or seats at a restaurant, spa, pool, etc. Additional examples of activities that may take place during the communicating step are discussed further below.

In addition to communicating data, the communication link established in step 202 may also be used for location tracking or localization. For example, the strength of the communication link or signal (e.g., Bluetooth) may be used for determining or confirming that the user device is still within a vicinity of the predetermined zone or a vicinity of the one or more anchors that was determined in the previous step via ultrawideband. If the strength of the communication link or signal is weaker than when the communication link or signal was first established, then the computing device may determine or conclude that the user device is no longer in the predetermined region. This may be a situation where a player or user has left the user device (e.g., a gaming table). It may be understood that the method or step of using the communication link or signal (e.g., Bluetooth) to determine, confirm, or estimate that the user device is or is not within the vicinity of the anchor or anchors may be less accurate than using other methods or steps disclosed herein (compared to using UWB, for example); however, such a method or step may be sufficient in certain instances, especially if UWB is not available at the particular time (i.e., the mobile device de-activates the UWB or is temporarily suspended).

The method may include a step of determining if the user device is still in the location or in the predetermined region or distance from the venue device that was detected in step 202. This determining step may be effected by measuring an initial signal strength of the communication link established in step 204 (i.e., baseline signal strength) and comparing it to a current signal strength of the communication link (current signal strength). Again, the communication link or signal may be a Bluetooth signal. If the current signal strength is substantially the same as the baseline signal strength, then the computing device, software, or algorithm may determine that the user and/or user device is still in the same location or general region. On the other hand, if the current signal strength is substantially less than or weaker than the baseline signal strength, then the computing device, software, or algorithm may determine that the user and/or user device is no longer in the same location or general region. This may be indicative of the user walking away from the venue device or gaming table. If it is determined that the user and/or user device is no longer in the same location or general region because the Bluetooth signal is weaker than the base line signal strength), then the computing device may end a player rating or may recommend to casino personnel to end the player rating.

Accordingly, the method may include a step of determining, using Bluetooth, if the user device is still in the location detected during the detecting step, wherein the determining step comprises identifying a baseline signal by measuring a Bluetooth signal strength of the electronic communication link initially established during the establishing step and then comparing the Bluetooth signal strength of the baseline signal to a current Bluetooth signal strength of the electronic communication between the user device and the venue device.

If the Bluetooth signal strength of the baseline signal is generally the same as the Bluetooth signal strength of the current signal, then the method comprises determining that the user device is still in the location detected during the detecting step. On the other hand, if the Bluetooth signal strength of the baseline signal is lower than the Bluetooth signal strength of the current signal, then the method comprises determining that the user device is no longer in the location detected during the detecting step.

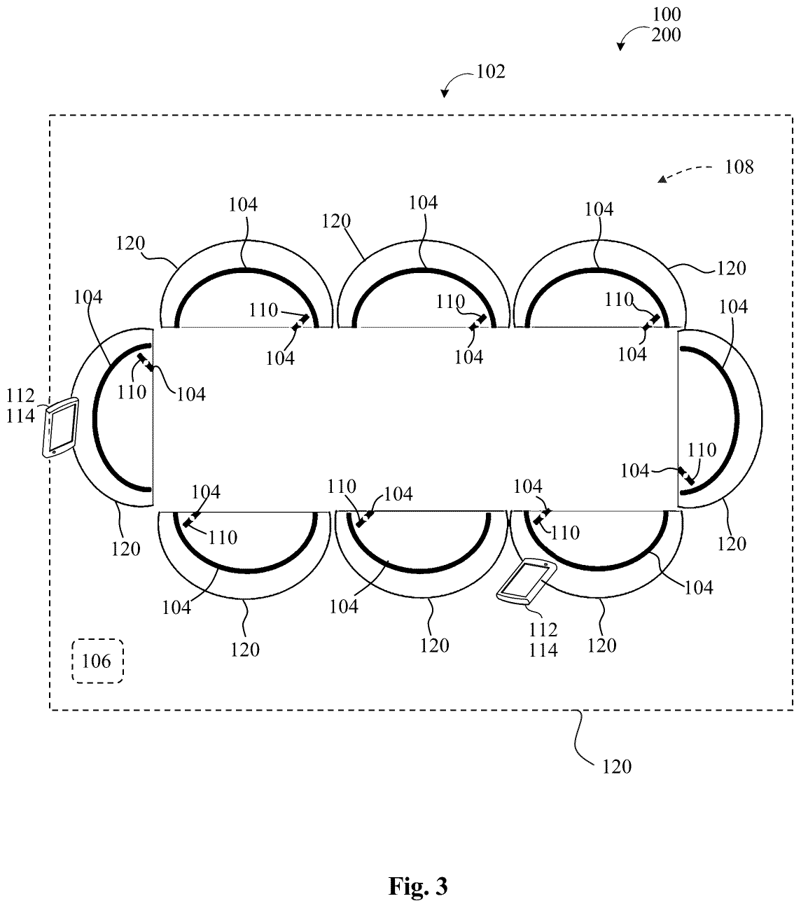

FIG. 3 illustrates an exemplary venue 102, comprising a plurality of venue devices 104, utilizing the system 100 and method 200 according to these teachings.

The known location of one or more of the anchors 110, the known dimensions of the venue 102, and the known location of the one or more venue devices 104 (which in this example may be a limit sign, display, gaming table, etc.) in the venue 102 may allow for the localization system 100 or the computing device 106 to create an XY or XYZ transactional boundary of the venue region 120. The venue region 120 in this example may be the region or area surrounding the individual tables 104 or the region surrounding multiple tables 104, such as a particular gaming room or area of the casino venue 102. For example, a venue region 120 may be a specific seat, chair, or playing position at a gaming table or a specific slot machine.

When a user or player with a user device 112 enters the venue 102 or venue region 120, a detector or detection device associated with the venue device 104 and/or the computing device 106, may detect or determine presence or a location of the user device 112 at or within a predetermined region or distance from the venue device 104 in the gaming venue 102 via one or more of the methods or steps disclosed herein.

After the user device 112 is detected or located, an electronic communication link between the user device 112 and the venue device 104 may be established. The communication link may take place over the network 108 via a suitable communication protocol such as Bluetooth or UWB.

The user device 112 and the venue device 104 may transmit (single direction or bi-directional communication) one or more signals or data over the communication link or network. The signals or data may include various information such as information relating to the user or a player profile associated with a user or the user device 104.

In some configurations, the method 200 or system 100 according to these teachings may enable or may be configured to enable the user to reserve a spot or chair at a venue device 104 (e.g., at a gaming table or slot machine) for later or future game play. This may advantageously allow a user to visit other venue devices while the user waits for a space to open at the desired venue device 104.

To book or reserve a venue device 104, after the communication link is established via the user device and the venue or venue device, the user may be required to send or provide a monetary deposit to the venue and/or the venue device to reserve the venue device for later gameplay or use. The deposit may be automatically sent or transmitted to the venue device or venue via the communication link at the time the reservation is initiated to complete the booking or reservation.

When the chair or spot at the venue device 104 becomes available, one or more signals may be communicated from the computing device 106, venue 102 or venue device 104 or anchor 110 to the tag 114 or user device 112 to notify the player of the available venue device. Such communication method may also consist of cellular, wifi, text, etc. When or after the player arrives at the venue device 104, within a predetermined and acceptable amount of time, and interacts with the venue device 104, for example by sitting at the gaming table, slot machine, or dining table, the localization system 100 may send and display a transaction code on a display screen of the venue device 104 and/or the user device 112 for the player to confirm reservation. In some configurations, a player will be notified of the amount of time in which they have to arrive at the venue device 104. If it is determined that the player is a known distance away from the venue device 104, and the estimated time to travel to the venue device 104 is close to the remaining time in the reservation, an alert may be communicated to the user device.

When or after the user arrives at the venue device 104, at least a portion of the monetary deposit may be applied towards gameplay at the venue device 104. In other implementations, at least a portion of the deposit may be returned to the user. However, if the user fails to arrive at the venue device 104 within the predetermined and acceptable amount of time, at least a portion of the monetary deposit may be forfeited to the venue 102 and/or the venue device 104.

The monetary deposit may be stored or kept in a digital wallet located on or accessible via the user device. In other configurations, the monetary deposit may be obtained from or returned to a financial institution. Transferring currency into and out of the digital wallet or financial institution may take place during one or of the method steps disclsoed herein, including the communication step.

In some configurations, the method 200 or system 100 according to these teachings may enable or may be configured to determine signals from a player's user device 112 while they are present at a venue device or table 104. The system 100 may be configured to detect when a player has left the table 104 by determining the user device 112 is no longer within the venue region 120 surrounding the table 104. After a player has left a venue device or 104, the localization system 100 may be configured to pause or end the player's rating depending on the settings in the localization system 100. This may also be dependent on other data acquired from sources such as shufflers, cameras, sensors, etc., to determine if the game is in a card changing or shuffle state. This may help identify a situation where a player is or intends to keep playing but has taken a break to use the restroom or take a phone call. In such a situation, the localization system 100 may be configured to pause the pause the player rating. If the player is detected as departing or has not returned to the table 104 for a predetermined amount of time, the localization system 100 may be configured to automatically end the rating. In other implementations, the localization system 100 may submit a recommendation to the casino staff to take action (e.g., pause or end the player rating) based on what the localization system 100 detects or identifies or determines.

Player relocation may occur when a player moves to a different table 104 but keeps playing. In a player relocation situation when the localization system 100 identifies a player relocation scenario, for example by identifying the player being seated at a different table 104 or in front of a different slot machine and in a playing position (possibly defined by another zone), the localization system 100 may stop the active rating at the previous table or slot machine, or may propose to the casino staff to stop the active rating and start a new rating at the new table or slot machine, or proposes a new rating to be started to the casino staff at the new table or slot machine.

In some configurations, a user may communicate, via the user device 112 and over the network 108, with a bar, kitchen, or restaurant in the venue 102 or venue region 120 to place an order for food and/or beverage. Ultra-wideband technology uses triangulation and an angle of arrival methodology to determine the location, position, and direction of the user device or venue device. Therefore, the computing device is able to determine the exact position, seat, location of the user device. Accordingly, because the location of the user device is known, the venue staff knows exactly where and to whom to deliver the food and/or beverage order. The venue may also communicate to the user an estimated time of arrival of the food/beverage. A map or other updates may be pushed by the computing device, venue or venue device to the user device so the user or player knows where his/her food/drink order is in the venue and when they can expect it to be delivered. Furthermore, information related to the beacon or tag associated to the venue device on or attached to the server tray or server, may be communicated to the players via a display at the table, such as a table sign, monitor, or TV for example.

In some configurations, a computing device may be configured to directly or indirectly (through a venue device for example) communicate with a user device (via Wifi, Cellular, BLE, etc.). For example, in some instances, it may be desirable for the computing device to send information or data to the user device as an alert or notification. The information may be sent to the user via the app, as an email message, and/or as a text message. For example, in the event of an emergency, the computing device may send instructions or alerts to the user device.

The computing device and/or the localization system may also be used for identifying a location of one or more person in the event of an evacuation situation, to ensure everyone has evacuated the venue. In other configurations, the computing device and/or localization system may be used for tracking a person, in the event a person of interest needs to be located. For example, a person who is not suppose to be in the venue (i.e., has been kicked out of banned) can be tracked, found, and escorted out in the event they enter the venue.

In some configurations, a user may communicate, via the user device 112 and over the network 108, with the venue device 104, to send and or receive funds from/to an electronic wallet and or financial institution. Such funds may be in the form of currency or substitute currency such as gaming chips used for wagering, TITO tickets, or other forms of non-currency items used by the casino.

For example, a user or player that wishes to leave a game or venue device may notify the dealer or make an appropriate election on the venue device screen. An option may be presented to the user to cash out and transfer the wagering chips to the electronic wallet or financial institution. The user may approve the transfer and be presented with a code on the user device. A user may compare the code or passkey to one on their user device to confirm the same code. Alternatively, the user may input the code into the user device to initiate the transfer from the venue or casino to the user device. The pending transaction will be solely linked to the player profile of the player cashing out, thus another player inputting the code would not work. Furthermore, the transfer may be initiated on the user device and transferred to the mobile wallet account based on the player profile. Mobile wallets may be stored on the user device or within an internal system on the casino.

In some configurations, when a user device 104 is detected within a venue region 120 according to any of the method or steps disclosed herein, a player rating associated with the user may be activated. Activation of the playwriting may take place automatically after it is determined by the venue 102, the venue device 104, and/or the computing device 106 that the user device 112 is present in the venue region 120. In other configurations, a recommendation or alert may be transmitted to a venue employee that the user device 112 is present in the venue region 120 and to recommend the venue employee to activate the player rating associated with the user or player. In some instances an overlay may occur on the hardware utilizing the player rating system of a pending rating. The system may store the data from the loyalty card. Taping the player rating, or selecting a button, may emulate the data the system is expecting to read from the previously used physical medium such as magnetic swipe data.

If it is determined, by any of the method steps herein, that the player or user device 112 is no longer present in the venue region 120 or venue 102, the system 100 and/or the computing device 106 may automatically deactivate the player rating. In other configurations, a recommendation or alert may be transmitted to a venue employee that the user device 112 is no longer present in the venue region 120 or venue 102 to recommend the venue employee to deactivate the player rating associated with the user or player.

If it is determined, by any of the method steps herein, that the player or user device 112 is no longer present in the venue region 120 or venue 102, the system 100 and/or the computing device 106 may end the electronic communication link between the user device 112 and the venue device 104 after the user device is no longer detected by the detector or detection device.

In another example, the anchors 110, or their antennas, located in the venue device 104 or sign 104 are in a known location or position on the venue device 104 or table. To determine a pit layout (i.e., where particular devices or tables 104 are located in the venue 102 or region 120), the localization system 100 may switch device over at a time from being an anchor to being a tag. When one of the anchors 110 which now function as a tag or beacon in this example emit its pulse, the other anchors 110 will send information to the one or more computing devices 106 to determine the location of the venue device or table 104 acting as a tag or beacon. Once this location is known, the localization system 100 may move on to the remaining tables 104 needing localization. Thereafter the system may regularly, or constantly, be configured to determine and/or verify the location of the venue device relative to other venue devices. If the venue device such as a gaming table, has an anchor installed on it with an established predetermined region, such region may be repositioned should they be relocated or the angle of the venue device is rotated.

Calibration of the one or more anchors at the table or venue device, relative to the other anchors or tables, may be useful for determining a layout of the venue or casino and the relative position or location of the predetermined zones. Therefore, if the venue changes a layout of a group of tables, so long as each table as an anchor, the system can determine the positioning of the tables or zone of interests, and display the same on a graphical interface. This may further enhance the overall accuracy of the system if a user device connects to multiple devices and needs to understand orientation. Furthermore, when the anchors use a method such as TDOA, accurate location information between anchors, as well as timing synchronization using the network, are paramount, thus accurate information as to location and proximity enhances location information for beacons or tags.

In another example, one or more tags may be placed at one or more venue devices (i.e., on/at one or more slot machines and/or tables). Using a TDOA method, the system and/or method according to these teachings can communicate with the one or more tags and anchors to identify a relative location and/or position of the one or more venue devices within the venue. This layout or position can be stored in the computing device as a reference or virtual map for future use, such as determining a relative position or location of one or more user devices or other venue devices within the virtual map.

As a practical application of this, a plurality of anchors can be located or placed throughout the venue (walls, floor, corners, etc.) and/or on venue devices (i.e., slot machines, gaming tables, etc.) The computing device 106 can communicate with the plurality of anchors to determine a relative location or position of the anchors relative to one another and/or within the venue using ultra-wide band localization and more specifically a TDOA method. The computing device 106 may then use the known positions from the anchors to create a virtual map of the venue and the venue devices within the venue. Thereafter, if a venue device is moved or a new venue device is added to the venue, the localization system can be recalibrated so that future TDOA methods are accurate for determining locations of other user devise and/or venue devise.

The dimensions of the tables 104 may be obtained by the localization system 100 or computing device 106 as well as the locations of the anchors 110. This data may be manually entered into the computing device 106 by an employee or agent or obtained in any other suitable manner. In some configurations, the zone of interest may be input into the localization system 100 or computing device 106 by using a tag or by mobile device or user device acting as a tag. The venue regions 120 will be applied to each table 102 based on pre-determined parameters set for distance in two dimension 2D or three dimension 3D around the perimeter of each table 104. In some implementations, a venue region 120 may be a transaction zone that a player is situated in when interacting with the venue device or table 104. In some configurations, the venue region 120 may be a region or space where a dealer is situated relative to the venue device or table 104.

The localization system 100 may track the location of one or more tags 114, including tags 114 associated with one or more players, throughout the casino venue 102 or venue region 120. In some implementations, the localization system 100 may obtain accelerometer data from an accelerometer of a user device 112, such as a player's smartphone to define trajectory to determine which table or venue device 104 the player is moving closer toward. The accelerometer data may supplement the UWB tracking data obtained by the anchors 110 tracking the tag 114 of the player.

The localization system 100 may determine the location of a tag 114 of a player when they elect to perform one or more transaction, such as, for example: a table transaction such as a buy-in, transferring from wagering account to table; a cash out, transferring the value of chips in the players possession to a wagering account; transfer their loyalty card data to a casino system that can input it into the rating system; and/or transfer or redeem a coupon at the gaming table.

It is understood that, unless otherwise expressly noted, use of the terms player cars and loyalty cards herein refer to the same type of card.

The localization system 100 may be used for identifying venue or casino employee production. For example, a tag may be given to a venue employee, such as a card table dealer. The tag may be applied on a lanyard or identification card. When the employee enters a pit area of the venue or casino, the computing device may determine presence of the employee by using the localization system and method according to these teachings (i.e., ultra-wideband localization via tags and anchors). The employee may then be automatically “tapped-in” without having to physically scan their card or enter identifying information into a system computer. When the employee walks away from the venue device, the localization system and method according to these teachings (i.e., ultra-wideband localization via tags and anchors and/or the Bluetooth signal strength comparison) may confirm that the employee is no longer at the table or venue device. The system may then automatically tap the employee out or the incoming dealer, using the same methodology being “tapped-in” may remove the previous dealer as the active dealer. Advantageously, the system and method according to these teachings may help a venue or casino track employee work time vs. non-working time, such as an employee taking a break or wandering around the venue.

After the location is established, the localization system 100 may provide the method or device for establishing a connection with a wagering account system for performing the transaction to a user device or mobile phone of the player or provide the mobile phone with information relating to the table that it is currently located at.

In some instances, ultrawide band, when using a plurality of anchors 110 for triangulation, may require consistent synchronization. In some implementations, the anchors 110 are connected to a network 108 via a hardwired connection. In other implementations, the anchors 110 are wirelessly connected to each other or to the WLAN via, e.g., ESP-Now for synchronization and/or data transfer. This wireless method may be Low-Latency. It is possible that a single anchor 110 broadcasts a time that the other anchors 110 are able to receive to keep the timing in sync. In some implementations, such a synchronization may occur outside of the existing network that is used for the localization and transactional processing. In some implementations, the localization system 100 dedicates a device that has a connection, wired or wireless, to this signal for localization processing. This unit could listen for packets from other devices with localization data and determine the location of the device in question.

The localization system 100 may interchangeably utilize numerous methods of UWB technology for localization. In addition to using UWB for localization, Bluetooth, Zigbee, or a comparable method of communication may be used to communicate once localization has determined the appropriate device to communicate with. Furthermore, the localization system 100 may use a Wi-Fi or cellular connection to communicate based on the localization information obtained. It is also possible that Bluetooth is not utilized and the established anchors 120 in which the mobile device is connected to, provide information to the tags 130, and vice versa, via data transmitted in pulses.

A communication method may indicate which user device(s) to connect to exchange localization, such as TWR. Therefore, the user device may identify a plurality of communication devices and connect to them to transmit TWR UWB details. The user device or the venue device may then determine location. When using the tags, the venue device may determine the location.

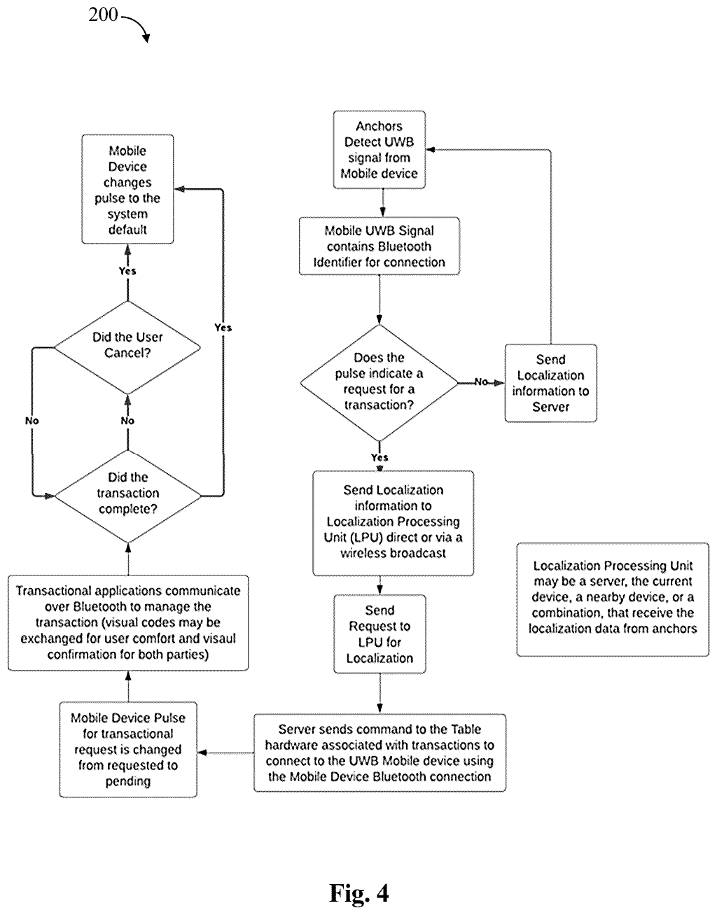

FIG. 4 is a flow diagram of an exemplary transaction associated with the system 100 and method 200 described herein.

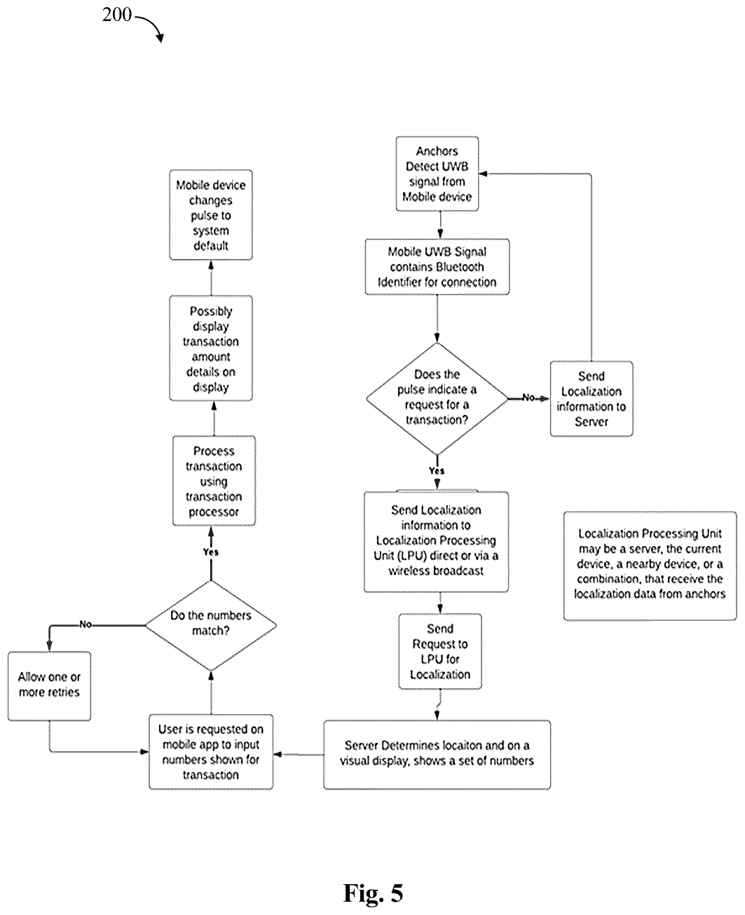

FIG. 5 is a flow diagram of an exemplary transaction associated with the system 100 and method 200 described herein.

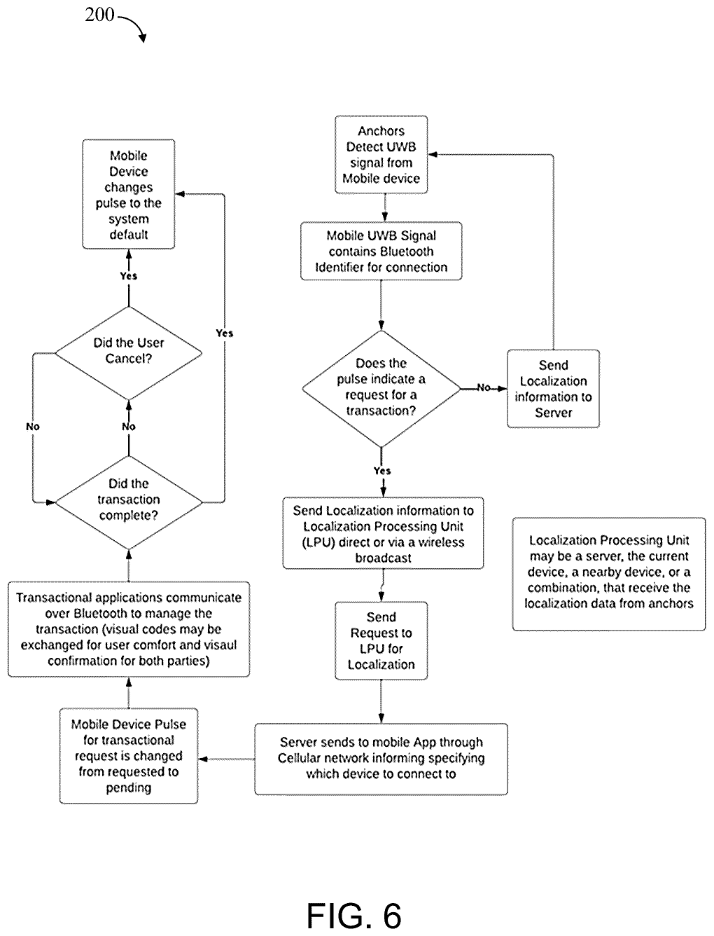

FIG. 6 is a flow diagram of an exemplary transaction associated with the system 100 and method 200 described herein.

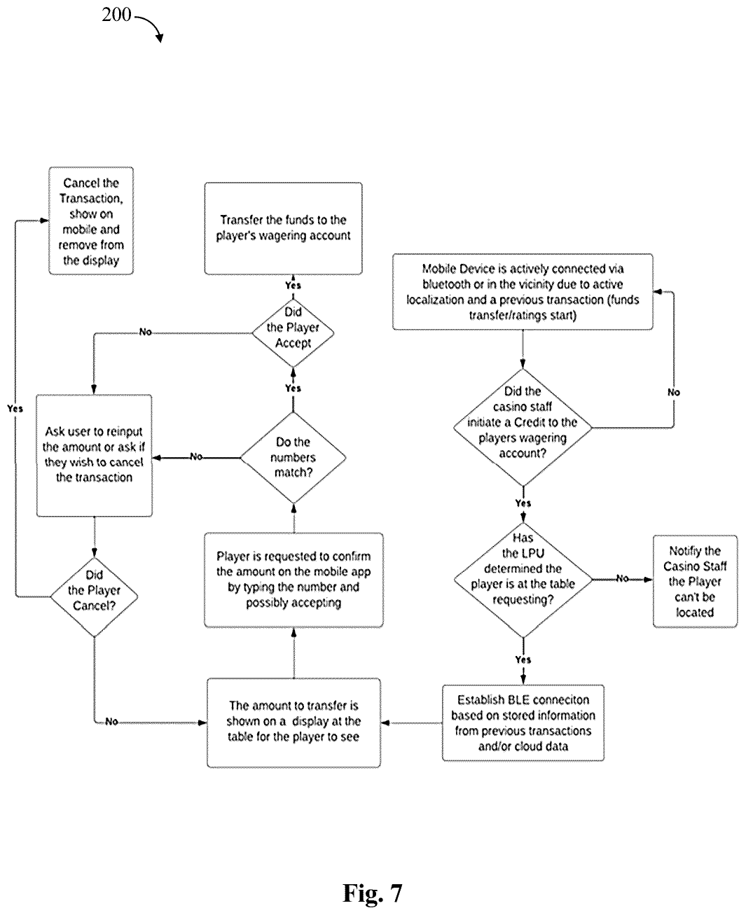

FIG. 7 is a flow diagram of an exemplary transaction associated with the system 100 and method 200 described herein.

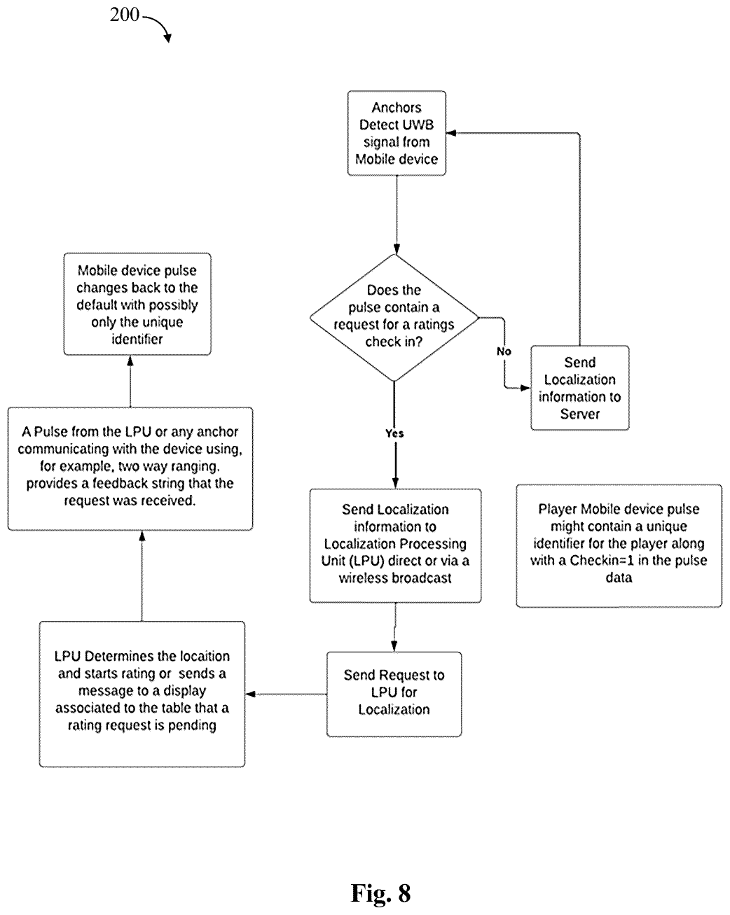

FIG. 8 is a flow diagram of an exemplary transaction associated with the system 100 and method 200 described herein.

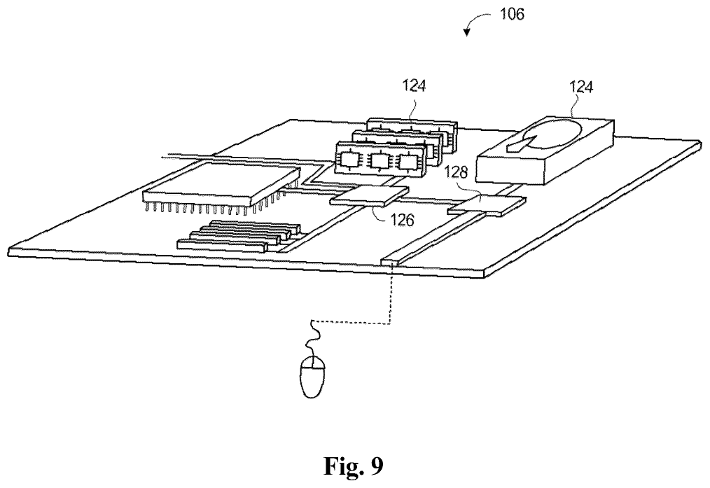

FIG. 9 is a schematic view of an example computing device 106 that may be used to implement the system 100 and method 200 described herein. The computing device 106 may generally include one or more processors 122, one or more memories 124, one or more interfaces/controllers 126, one or more communication ports 128 for receiving and sending data or signals, and one or more computer programs or algorithms that are configured to execute one or more of the steps of the method 200 according to these teachings.

One of more of the computing device components may be interconnected using various busses, and may be mounted on a common motherboard or in other manners as appropriate.

The processor may be configured to process instructions for execution within the computing device, including instructions stored in the memory, to display graphical information for a graphical user interface (GUI) on an external input/output device, such as display coupled to high speed interface. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory may store information non-transitorily within the computing device. The memory may be a computer-readable medium, a volatile memory unit(s), or non-volatile memory unit(s). The non-transitory memory may be physical devices used to store programs (e.g., sequences of instructions) or data (e.g., program state information) on a temporary or permanent basis for use by the computing device. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device may be capable of providing mass storage for the computing device. In some implementations, the storage device is a computer-readable medium. In various different implementations, the storage device may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described herein. The information carrier is a computer- or machine-readable medium, such as the memory, the storage device, or memory on processor.

A high speed controller manages bandwidth-intensive operations for the computing device, while a low speed controller manages lower bandwidth-intensive operations. Such allocation of duties is exemplary only. In some implementations, the high-speed controller is coupled to the memory, the display (e.g., through a graphics processor or accelerator), and to the high-speed expansion ports, which may accept various expansion cards (not shown). In some implementations, the low-speed controller is coupled to the storage device and a low-speed expansion port. The low-speed expansion port, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device may be implemented in a number of different forms. For example, it may be implemented as a standard server or multiple times in a group of such servers, as a laptop computer, as part of a rack server system, as a tablet computer, or as a smartphone. As discussed above, one or more anchors may function as a computing device. In such a configuration, the one or more anchors may comprise one or more features or capabilities of the computing device so that the anchor can perform one or more of the functions of the computing device disclosed herein. Accordingly, an anchor may be a computing device and/or vice versa.

In some instances, reference is made to a venue anchor. As has been stated here in, an anchor may be incorporated into a venue or a venue device. Accordingly, an anchor that is incorporated into a venue device may be referred to as a venue device anchor. An anchor that is incorporated into the venue, such as being located in the ceiling, walls, floor of the venue, may be referred to as a venue anchor. However, it is understood that the anchors, whether a venue device anchor or a venue anchor, function in a similar manner according to the teachings herein.

Various implementations of the systems and method steps described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A mobile application or software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

1. A method of communicating between a user device and a venue device located within a gaming venue, the method comprising:
a) establishing an electronic communication link, using a Bluetooth signal, between the user device and at least one venue device within a range of the user device in the gaming venue;
b) detecting, by either:
i. a detector of the venue device, using ultra-wideband localization, presence or location of the user device relative to the venue device; or
ii. a detector of the user device, using ultra-wideband localization, presence or location of the venue device relative to the user device;
and then:
c) communicating, by a mobile application residing on the user device, with the venue device, via the electronic communication link and/or via Wifi or a cellular network.

2. The method according to claim 1, wherein the method comprises: determining, using the Bluetooth signal, if the user device is still present in a predetermined region of the gaming venue, wherein the determining step comprises identifying a strength of one or more baseline Bluetooth signals initially established during the establishing step and then comparing the strength of the one or more baseline Bluetooth signals to a strength of one or more current Bluetooth signals.

3. The method according to claim 2, wherein if the strength of the one or more baseline Bluetooth signals is generally the same as the strength of the one or more current Bluetooth signals, then the method comprises determining that the user device is still present in the predetermined region of the gaming venue.

4. The method according to claim 3, wherein if the strength of the one or more baseline Bluetooth signals is significantly different than the strength of the one or more current Bluetooth signals by a predetermined amount, then the method comprises determining that the user device is still present in the predetermined region of the gaming venue.

5. The method according to claim 3, wherein if the strength of the one or more baseline Bluetooth signals is less than the signal strength of the one or more current Bluetooth signals varies by a predetermined amount, then the method comprises determining that the user device is no longer in the predetermined region of the gaming venue or is moving away from the predetermined region at the one or more venue device and/or the gaming venue.

6. The method according to claim 1, wherein the communicating step comprises: reserving a spot or chair for current or future game play at the venue device or at another venue device by communicating a request, by the mobile application residing on the user device, to the venue device and/or to a computing device; and optionally the method comprises sending a monetary deposit to the venue and/or the venue device, by the mobile application residing on the user device, to reserve the spot or chair at the venue device.

7. The method according to claim 6, wherein the method comprises forfeiting the monetary deposit to the venue and/or the venue device if a user does not arrive at the spot or chair at the venue device within a predetermined amount of time; or applying, at least a portion of the monetary deposit no portion of the monetary deposit, towards game play at the venue and/or the venue device if the user arrives at the spot or chair within the predetermined amount of time.

8. The method according to claim 1, wherein the communicating step comprises placing an order for food and/or beverage with the venue using the mobile application.

9. The method according to claim 1, wherein the communicating step comprises debiting or crediting funds via the venue device, the venue, a mobile wallet affiliated with the gaming venue, and/or a financial institution.

10. The method according to claim 1, wherein the communicating step comprises activating a player rating associated with a user of the user device after the user device is detected by the detector using the ultra-wideband localization and the user initiates and confirms the communication link.

11. The method according to claim 1, wherein the method comprises sending a recommendation to the venue device and/or a venue employee to activate a player rating associated with a user of the user device after the user device is detected by the detector using the ultra-wideband localization; and/or deactivating a player rating associated with the user after the user device is no longer detected by the detector of the venue device.

12. The method according to claim 1, wherein the method comprises sending a recommendation to the venue device and/or a venue employee to deactivate a player rating associated with the user after the user device is no longer detected by the detector using the ultra-wideband localization and/or Bluetooth; and/or the method according to claim 1, wherein the method comprises ending the electronic communication link between the user device and the venue device after the user device is no longer detected by the detector using the ultra-wideband localization and/or Bluetooth.

13. The method according to claim 1, wherein the detecting step comprises using a two-way ranging method (TWR).

14. The method according to claim 1, wherein the user device is a smart phone or wearable technology, and the gaming venue is a casino, and the venue device is a gaming table or a slot machine.

15. The method according to claim 1, wherein the method comprises: determining, using the Bluetooth signal, if the user device is still present in a predetermined region of the gaming venue, wherein the determining step comprises identifying a strength of one or more baseline Bluetooth signals initially established during the establishing step and then comparing the strength of the one or more baseline Bluetooth signals to a strength of one or more current Bluetooth signals;
wherein:
a) if the strength of the one or more baseline Bluetooth signals is generally the same as the strength of the one or more current Bluetooth signals, then the method comprises determining that the user device is still present in the predetermined region of the gaming venue; and/or
b) if the strength of the one or more baseline Bluetooth signals is varies from the strength of the one or more current Bluetooth signals, then the method comprises determining that the user device is no longer present in the predetermined region of the gaming venue.

16. The method according to claim 15, wherein in or during the communicating step, the method comprises one or more steps from a list consisting essentially of:
a) reserving a spot or chair for current or future game play at the venue device or at another venue device by communicating a request, by the mobile application residing on the user device, to the venue device and/or to a computing device;
b) sending a monetary deposit to the venue and/or the venue device, by the mobile application residing on the user device, to reserve the spot or chair at the venue device;
c) placing an order for food and/or beverage with the venue using the mobile application;
d) debiting or crediting funds via the venue device, the venue, and/or a financial institution;
e) activating a activating a player rating associated with a user of the user device after the user device is detected by the detector using the ultra-wideband localization and the user initiates and confirms the communication link; and
f) ending a recommendation to the venue device and/or a venue employee to activate a player rating associated with a user of the user device after the user device is detected by the detector using the ultra-wideband localization.

17. A method of creating a virtual map of a gaming venue using ultra-wideband localization, wherein the method comprises:
a) identifying the one or more venue devices within the gaming venue using the ultra-wideband localization, wherein at least one of the one or more venue devices comprises an anchor and/or tag that is configured to communicate with a computing device to determine a relative position of the one or more venue devices within the gaming venue; and
b) recalibrating, with a processor of the computing device, the virtual map of the venue device and a position of the one or more venue devices within the gaming venue in the event one or more of the venue devices are moved or one or more venue devices are added to the gaming venue.

18. The method according to claim 17, wherein the identifying step utilizes a TDOA method.

19. A method of creating a virtual map of a gaming venue using ultra-wideband localization, wherein the method comprises: identifying one or more venue devices within the gaming venue using the ultra-wideband localization, wherein at least one of the one or more venue devices comprises an anchor in which an orientation of the anchor is determined by a computing device using ultra-wideband localization to define regions of interest and sub regions of interest in close proximity to the venue device, the anchor is configured to electronically communicate with one or more of the other venue devices that comprise one or more additional anchors and/or venue anchors for the computing device to determine a relative position of the one or more venue devices within the gaming venue, wherein the one or more anchors are configured to create a mesh to enable triangulation of tags associated with other venue devices.

20. The method according to claim 19, wherein the mobile application is configured for wayfinding and/or location identification using the user device and the detection method.
